(19) United States
(12) Patent Application Publication
(10) Pub. No.: US 2008/0099091 A1
(43) Pub. Date: May 1, 2008

(54) Combination spout stop/bottom bushing

(76) Inventor: Evan A. Benstead, Los Angeles, CA (US)

Correspondence Address: THE BLACK & DECKER CORPORATION, 701 EAST JOPPA ROAD, TW199, TOWSON, MD, 21286, US

(21) Appl. No.: 11/586,263

(22) Filed: Oct. 25, 2006

(51) Int. Cl. F16K 21/00

(52) U.S. Cl. 137/801

(57) ABSTRACT

A faucet assembly includes a faucet housing including at least one rotational limit feature positioned with respect to an axis. A spout assembly includes a spout, the spout having attached thereto a stop member positioned to engage the rotational limit feature when the spout is rotated about the axis.

### BACKGROUND OF THE INVENTION

1. Field of the Invention

The present invention relates to faucets, and, more particularly, to a combination spout stop and bottom bushing for use with a faucet.

2. Description of the Related Art

A typical faucet, such as a kitchen faucet, has a movable spout that can be rotated to supply water to a desired location, such as for example, to either of two sink bowls. One problem associated with such a design, however, that the spout may be rotated too far, resulting in water being sprayed onto the countertop behind the sink. Also, in some configurations the spout may be rotated in a full 360 rotation and beyond, which may result in the tangling of a pull-out hose located in the spout.

### SUMMARY OF THE INVENTION

The present invention provides a limit stop arrangement for the spout, so that the spout can only rotate by a fixed amount, such as for example approximately 150 degrees, instead of 360 degrees.

The present invention, in form thereof, is directed to a faucet assembly. The faucet assembly includes a faucet housing including at least one rotational limit feature positioned with respect to an axis. A spout assembly includes a spout, the spout having attached thereto a stop member positioned to engage the rotational limit feature when the spout is rotated about the axis.

The present invention, in another form thereof, is directed to a bushing for a faucet assembly. The bushing includes a cylindrical bushing body having an inner side surface and an outer side surface. An axis passes through the cylindrical body. At least one cantilever spring member is formed in the cylindrical bushing body. Each cantilever spring member has at its free end a tab that extends inwardly toward the axis beyond the inner side surface. A stop member is formed as an annular lip that extends outwardly away from the axis beyond the outer side surface.

The present invention, in another form thereof, is directed to a method for assembling a faucet assembly, including attaching a bushing having a stop member to a spout; inserting the bushing into a cylindrical member of a faucet housing; and positioning the stop member between a pair of rotational limit features located on the cylindrical member.

The present invention, in another form thereof, is directed to a method for assembling a faucet assembly, including inserting an upper bushing into an upper opening of a spout housing; passing an end of a spout down through the upper bushing in the spout housing; installing a lower bushing over the end of the spout; and sliding the lower bushing over an elongate portion of the spout until a spring tab of the bushing engages a corresponding annular slot of the spout.

One advantage of the present invention is that it helps to avoid tangling a pull-out hose located inside the spout by over rotation of the spout.

Another advantage of the present invention is that the limit stop also serves as the bottom bushing for the spout.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is an exploded perspective view of a faucet assembly embodying the present invention.

FIG. 2 is a top view of the bushing having a limit stop that is inserted into the bushing housing of the faucet assembly of FIG. 1.

FIG. 3 is a flowchart of a method for assembling the faucet assembly of FIG. 1.

Corresponding reference characters indicate corresponding parts throughout the several views. The exemplifications set out herein illustrate an embodiment of the invention, and such exemplifications are not to be construed as limiting the scope of the invention in any manner.

### DETAILED DESCRIPTION OF THE INVENTION

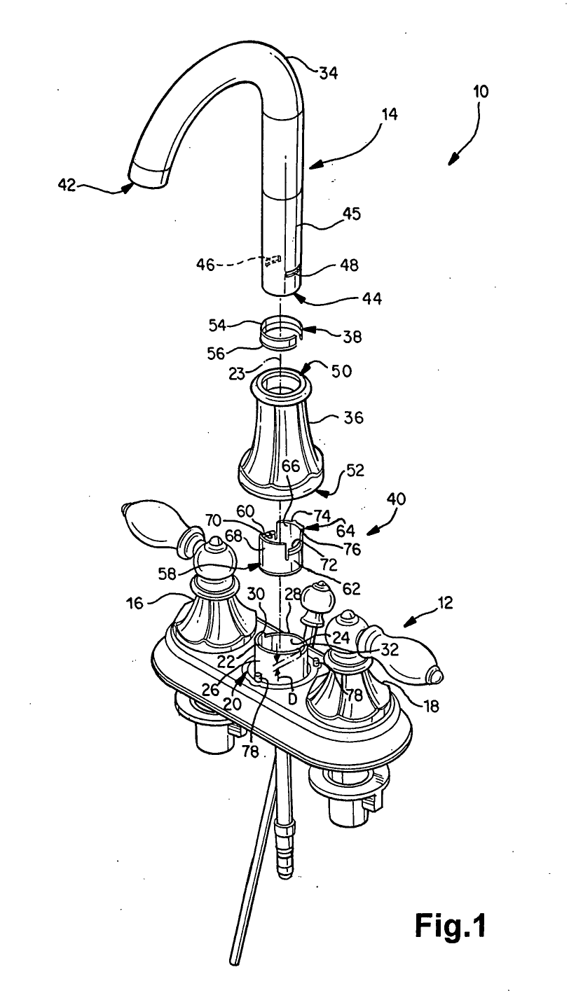

Referring now to the drawings and particularly to FIG. 1, there is shown a faucet assembly 10 embodying the present invention.

Faucet assembly 10 includes a faucet housing 12 and a spout assembly 14.

Faucet housing 12 has installed therein a hot water valve assembly 16 and a cold water valve assembly 18. Faucet housing 12 includes a body 20 for rotatably mounting spout assembly 14. Body 20 includes a cylindrical member 22 having an axis 23.

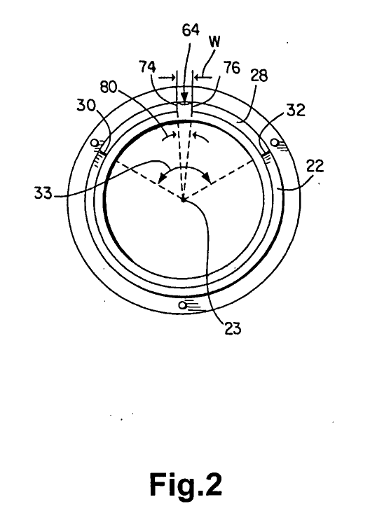

Referring also to FIG. 2, cylindrical member 22 includes an inner surface 24, an outer surface 26, and a circumferential channel 28 defining a pair of rotational limit features 30, 32. Circumferential channel 28 and rotational limit features 30, 32 may be formed in cylindrical member 22, for example, by removing an annular portion of cylindrical member 22, thereby forming a cut-out having a predetermined depth D and providing a predetermined angular separation of rotational limit features 30, 32 at an angle 33 (see FIG. 2) with respect to axis 23. Each of rotational limit features 30, 32 formed in cylindrical member 22 radially extend from inner surface 24 to outer surface 26.

Spout assembly 14 includes a spout 34, a spout housing 36, an upper bushing 38, and a lower bushing 40. Axis 23 also forms the axis of spout 34, spout housing 36, upper bushing 38, and lower bushing 40

Spout 34 includes a first end 42, a second end 44, and an elongate portion 45. A spray head (not shown) extends from first end 42. Annular slots 46, 48 are formed through elongate portion 45 near second end 44.

Spout housing 36 includes an upper opening 50 and a lower opening 52.

Upper bushing 38 may be, for example, a split ring having outer shoulders 54, 56. When compressed, upper bushing 38 is inserted into upper opening 50 of spout housing 36, and then when released is held in position in spout housing 36 by outer shoulders 54, 56.

Lower bushing 40 includes a cylindrical bushing body 58, a cantilever spring member 60, a cantilever spring member 62, and a stop member 64. Cylindrical bushing body 58 has an inner side surface 66 and an outer side surface 68. Cantilever spring member 60 and cantilever spring member 62 may be formed, respectively, by a pair of axial slits passing from outer side surface 68 to inner side surface 66. Cantilever spring member 60 has at its free end a tab 70 that extends inwardly toward axis 23 beyond inner side surface 66. Cantilever spring member 62 has at its free end a tab 72 that extends inwardly toward axis 23. Thus, tabs 70, 72 are sometimes referred to herein for convenience as spring tabs 70, 72, due to their presence on respective cantilever spring members 60, 62. Tab 70 and tab 72 are sized to be received in annular slots 46, 48 of spout 34, respectively.

Stop member 64 is formed as an annular lip that extends outwardly away from axis 23 beyond outer side surface 68. Stop member 64 is arranged to be received in circumferential channel 28 of cylindrical member 22 of faucet housing 12. Stop member 64 includes a stop surface 74 and a stop surface 76 which respectively engage rotational limit features 30, 32 formed in cylindrical member 22 of faucet housing 12 when spout 34 is rotated about axis 23, depending on the direction of rotation.

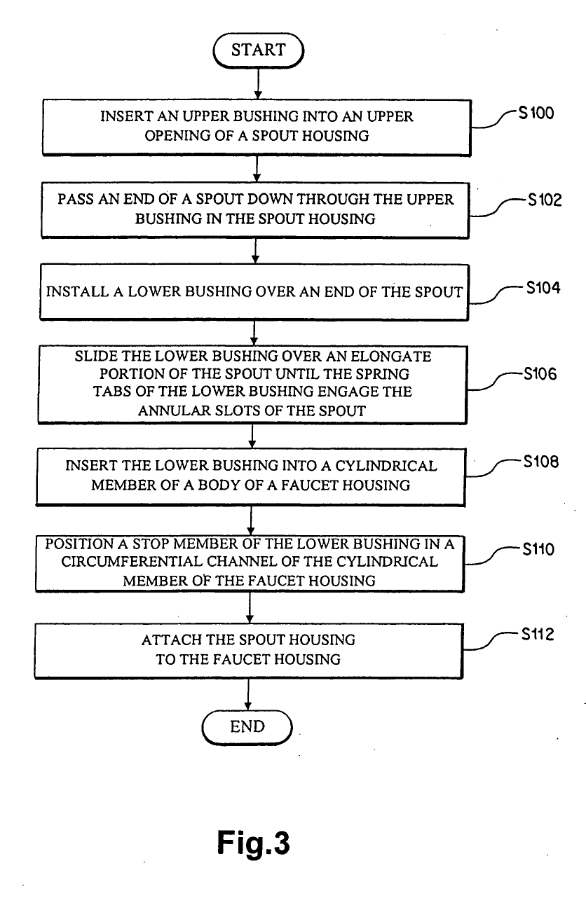

A method for assembling faucet assembly 10 will now be described with further reference to the flowchart of FIG. 3, including steps S100-S112. In general, spout assembly 14 is formed by steps S100-S106, and the spout assembly 14 is mounted to faucet housing 12 by steps S108-S112.

At step S100, upper bushing 38 is inserted into upper opening 50 of spout housing 36.

At step S102, second end 44 of spout 34 is passed down through upper bushing 38 in spout housing 36.

At step S104, lower bushing 40 is then installed over second end 44 of spout 34.

At step S106, lower bushing 40 is slid over elongate portion 45 of spout 34 until spring tabs 70, 72 engage annular slots 46, 48 of spout 34, respectively.

At step S108, lower bushing 40 is inserted into cylindrical member 22 of body 20 of faucet housing 12.

At step S110, stop member 64 is positioned in circumferential channel 28 of cylindrical member 22 of faucet housing 12.

At step S112, spout housing 36 of spout assembly 14 is attached to faucet housing 12, such as for example, by using a plurality of fasteners 78, such as screws.

During operation, spout 34 may be rotated about axis 23, but the extent of the rotation is limited by the interaction of stop member 64 of lower bushing 40 with the rotational limit features 30, 32 defined by the ends of circumferential channel 28 formed in cylindrical member 22 of faucet housing 12. Referring to FIG. 1, stop surface 74 of stop member 64 engages rotational limit feature 30 of faucet housing 12 when spout 34 is rotated around axis 23 in a counterclockwise rotational direction. Likewise, stop surface 76 of stop member 64 engages rotational limit feature 32 of faucet housing 12 when spout 34 is rotated around axis 23 in a clockwise rotational direction.

Referring again to FIG. 2, the extent of the rotation of spout 34 about axis 23 is determined by the width W of stop member 64, i.e., the distance, or angular separation at angle 80, between stop surfaces 74, 76 of stop member 64, and also by the angular separation by angle 33 of rotational limit features 30, 32 of circumferential channel 28 formed in cylindrical member 22 of faucet housing 12. Accordingly, the angular extent to which spout 34 may be rotated about axis 23 may be selected, for example, based on a selection of an appropriate combination of the width W of stop member 64 and the angular separation by angle 33 of rotational limit features 30, 32. In one embodiment, for example, the combination of the width W of stop member 64 and the angular separation by angle 33 of rotational limit features 30, 32 may be selected to limit the angular extent to which spout 34 may be rotated about axis 23 to about 150 degrees.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A faucet assembly, comprising:
a faucet housing including at least one rotational limit feature positioned with respect to an axis; and
a spout assembly including a spout, said spout having attached thereto a stop member positioned to engage said at least one rotational limit feature when said spout is rotated about said axis.

2. The faucet assembly of claim 1, wherein said at least one rotational limit feature includes a first limit feature and a second limit feature, said first limit feature being separated from said second limit feature at a predetermined angular separation with respect to said axis.

3. The faucet assembly of claim 2, wherein said stop member includes a first stop surface which engages said first limit feature when said spout is rotated about said axis in a first rotational direction, and said stop member includes a second stop surface which engages said second limit feature when said spout is rotated about said axis in a second rotational direction opposite to said first rotational direction.

4. The faucet assembly of claim 3, wherein said first stop surface is separated from said second stop surface by another predetermined angular separation with respect to said axis.

5. The faucet assembly of claim 1, wherein said faucet housing includes a cylindrical member having a circumferential channel defining a pair of rotational limit features.

6. The faucet assembly of claim 5, wherein said pair of rotational limit features is positioned at a predetermined angular separation with respect to said axis.

7. The faucet assembly of claim 5, wherein said circumferential channel and said pair of rotational limit features are formed in said cylindrical member by removing an annular portion of said cylindrical member.

8. The faucet assembly of claim 1, wherein:
said spout assembly further includes a bushing including said stop member, said bushing being attached to said spout;
wherein said faucet housing includes a cylindrical member having a circumferential channel defining a pair of rotational limit features; and
said bushing being positioned in said cylindrical member with said stop member being received in said circumferential channel between said pair of rotational limit features.

9. The faucet assembly of claim 1, wherein said spout assembly includes a bushing, said bushing being attached to said spout and said bushing including said stop member.

10. The faucet assembly of claim 9, wherein said spout includes an annular slot, and said bushing includes a cantilever spring member having a tab positioned to engage said annular slot of said spout for attachment of said bushing to said spout.

11. A bushing for a faucet assembly, comprising:
a cylindrical bushing body having an inner side surface and an outer side surface, and an axis passing through said cylindrical body;
at least one cantilever spring member formed in said cylindrical bushing body, each said cantilever spring member having at its free end a tab that extends inwardly toward said axis beyond said inner side surface; and
a stop member formed as an annular lip that extends outwardly away from said axis beyond said outer side surface.

12. A method for assembling a faucet assembly, comprising:
attaching a bushing having a stop member to a spout;
inserting said bushing into a cylindrical member of a faucet housing; and
positioning said stop member between a pair of rotational limit features located on said cylindrical member.

13. The method of claim 12, wherein said spout includes an annular slot, and said bushing includes a cantilever spring member having a tab, the method further comprising:
inserting an end of said spout in said bushing; and
engaging said tab of said bushing with said annular slot of said spout.

14. A method for assembling a faucet assembly, comprising:
inserting an upper bushing into an upper opening of a spout housing;
passing an end of a spout down through said upper bushing in said spout housing;
installing a lower bushing over said end of said spout; and
sliding said lower bushing over an elongate portion of said spout until a spring tab of said bushing engages a corresponding annular slot of said spout.

15. The method of claim 14, further comprising:
inserting said lower bushing into a cylindrical member of a faucet housing;
positioning a stop member located on said lower bushing in a circumferential channel of said cylindrical member of said faucet housing; and
attaching said spout housing to said faucet housing.
